(19) United States
(12) Patent Application Publication
(10) Pub. No.: US 2019/0311329 A1
(43) Pub. Date: Oct. 10, 2019

(54) Decision Making Add-on System

(71) Applicant: Darryl Clines, Saint Louis, MO (US)

(72) Inventor: Darryl Clines, Saint Louis, MO (US)

(21) Appl. No.: 15/396,661

(22) Filed: Jan. 1, 2017

(51) Int. Cl. G06Q 10/10; G06Q 10/06; G06F 16/951

(52) U.S. Cl. CPC G06Q 10/1053; G06F 16/951; G06Q 10/06395

(57) ABSTRACT

A system, method and computer readable indexing and storage medium, for generating historical data, is provided which, based on historical accounts and records, assist in the decision making process as it relates to human resources and the management of the field supply and demand. The data collected by way of personal entries, provides a personalized experience for the recruitment navigational and the benefit assignment tools. The imported data portion accesses the central database records comprising of employee write-ups, awards, recommendations, pink slips, promotions, etc. Depending on the data attached to a specific profile, the system will rank the hiring potential of a job seeking applicant, the providers of opportunities and the eligibility of the pursuers of program benefits. The system will be designed to interact with all communication platforms (mobile, tablets, PCs, laptops etc.). Other methods and apparatuses are also described.

### FIELD OF THE INVENTION

The present invention relates generally to internet based software applications; and more particularly to application software that is downloaded and operable across the Internet.

### BACKGROUND OF THE INVENTION

No matter what kind of business you run, your success or failure depends largely on the quality of your staff. The hiring process, including everything from writing a job description to conducting interviews and choosing the best candidates, should always be done with careful attention to detail. There are also a host of considerations that have to be address in the employment and or recruitment of new talent; some of those are inclusive of job advertisements, interview protocols, background checks and a number of other related issues.

The first step in the hiring process is, of course, to apply for jobs and get your application into contention for the jobs you are interested in. Once you have applied, applicant tracking systems are used by many employers to process job applications and manage the hiring process. Applicant tracking systems provide an automated way for companies to manage the entire recruiting process, from receiving applications to hiring employees.

Many companies have an involved interview process starting with screening interviews, followed by in-person interviews, second interviews and even third interviews. It is at this time some companies test applicants for employment, to determine if the candidate is a good match for the jobs they are hiring for. Companies who conduct pre-employment tests (talent assessments) are seeking applicants that match their hiring criteria.

Jobs may be offered to applicants, contingent upon the successful vetting of an applicant's background check and or a credit check. Or, a background check may be conducted prior to a company offering a job. What the company learns during the background check could result in a job offer or the job offer being withdrawn.

After making it through the challenging hiring process, the final step is always the job offer. In fulfillment of the job offer, completing the paperwork precedes the formal invitation of joining the workforce of the company.

### BRIEF SUMMARY OF THE INVENTION

In psychology, decision-making is regarded as the cognitive process resulting in the selection of a belief or a course of action among several alternative possibilities. Every decision-making process produces a final choice that may or may not prompt action. Decision-making is the process of identifying and choosing alternatives based on the values and preferences of the decision maker. The Decision Making Add-on System is a software application designed to assist Employers with performing a detailed assessment of prospective employees, aiding in the Employer's final decision of hiring or withdrawing a job offer. The Decision Making Add-on System will facilitate the exchange of work-related documents between the employee, employer, the appropriate governing bodies and support organizations; perform background checks, for Employers on requested prospective employees, within the system and or in cooperation with an outside entity. The Decision Making Add-on System will also collect all discoverable content points on each employee/job seeker profile field user, to personalize each individual profile, assigning a profile rank to each employee/job seeker profile, system wide.

### Brief Description of Applied Technology Components:

A proxy or a proxy server acts as another computer which serves as a hub through which internet requests are processed. By connecting through one of these servers, a computer sends a request to the proxy server which then processes the request and returns what was/is requested. Proxies are used for a number of reasons, such as to filter web content, to go around restrictions such as parental blocks, to screen downloads and upload, and to provide anonymity when surfing the internet. Proxies are also used like search engines, except that you enter a website address instead of a search query into a form, returning web pages rather than search results, without being required to install additional software or system modifications to the computer networking settings.

Document Conversion software acts in converting one or more document format to another, which allows the document to be read in many more applications. Documents can be converted into: 1) other source document formats; 2) consumer formats; 3) structured data.

Indexing collects, parses and stores data to facilitate fast and accurate information retrieval. The purpose of storing an index is to optimize speed and performance in finding relevant documents for a search query.

Disclaimer: The following images depict the composition of the “Decision Making Add-on System” in multiple and progressive component structure formats. The decision to illustrate the system in an expanded format is not a suggestion that this process can only be accomplished within this setting or limited to this design template. The decision to select this setting for the multi-phased system was solely an attempt to relate the principles of the methodology in a fundamental setting to establish a logical correlation. The position of component structures, the size of components and/or the number of structures visible should not be assumed as definitive and/or absolute in accomplishing the desired tasks. It will also become apparent, however, to one skilled in the art, that the embodiments of the present invention may be practiced without these specific details. In other instances, well-known structures and devices are shown in block diagram form, within the “Drawings” submission, rather than in detail, in order to avoid obscuring the embodiments of the present invention. The following images are for illustrative purposes only and should solely be interpreted as such.

Reference in the specification to “one embodiment” or “an embodiment” means that a particular feature, structure, or characteristic described in connection with the embodiment is included in at least one embodiment of the invention. The appearances of the phase “in one embodiment” in various places in the specification do not necessarily all refer to the same embodiment. According to certain embodiments of the invention, a defined approach is utilized to reach full spectrum customers, who will selectively adopt content delivered by a content and/or service provider. (The content can be Best Practice packages available from a pre-produced repository of the content/service provider, or customized packages formed by select-to-use content.) Standard content provides distinct intended low cost, which is the focus of midsize market customers. During a valid subscription period, a customer can subscribe updated content according to its needs. Meanwhile, the content will be updated and stay relevant. New job seekers/employees/employers will save the hassle of implementing generic content. A continuous and close feedback loop tailors standard release portfolios according to market requirements which are based on the trend of customer content requirements and the content/service provider's expectations. Thus, while a content/service provider is focusing on standardized country, industry, as well as requestor-specific requirements (e.g., make-to-order or on-demand), the content/service provider needs an industrialized service center to consistently provide intended low-cost pre-defined content and remote service to customers, partners and the content/service provider internal, including field and development.

### BRIEF DESCRIPTION OF THE SEVERAL VIEWS OF THE DRAWING: Phase 1

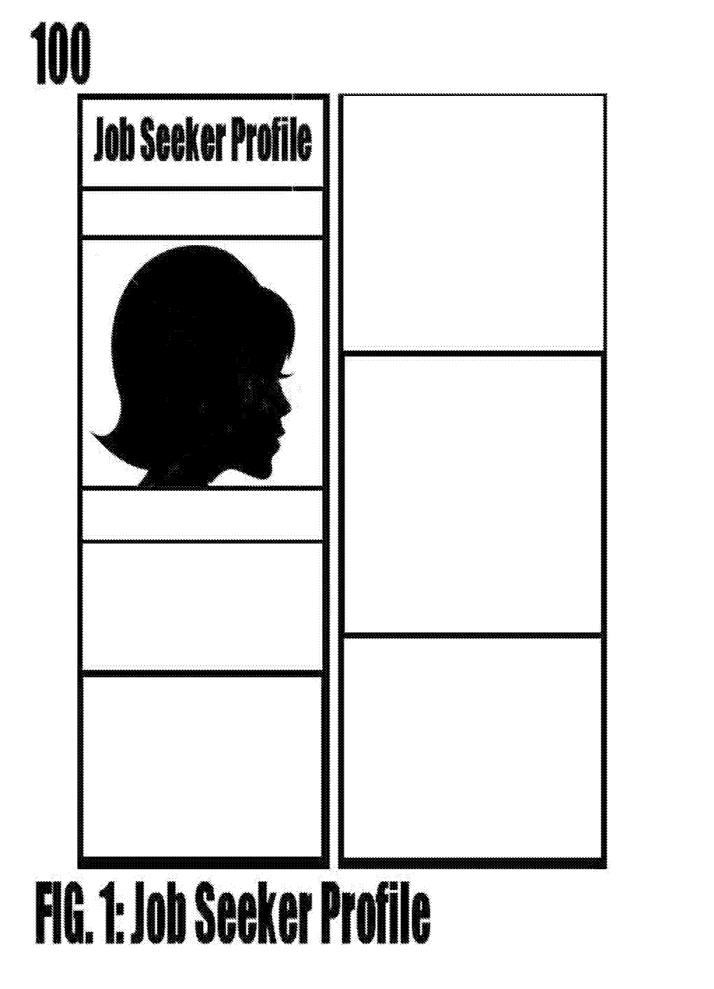

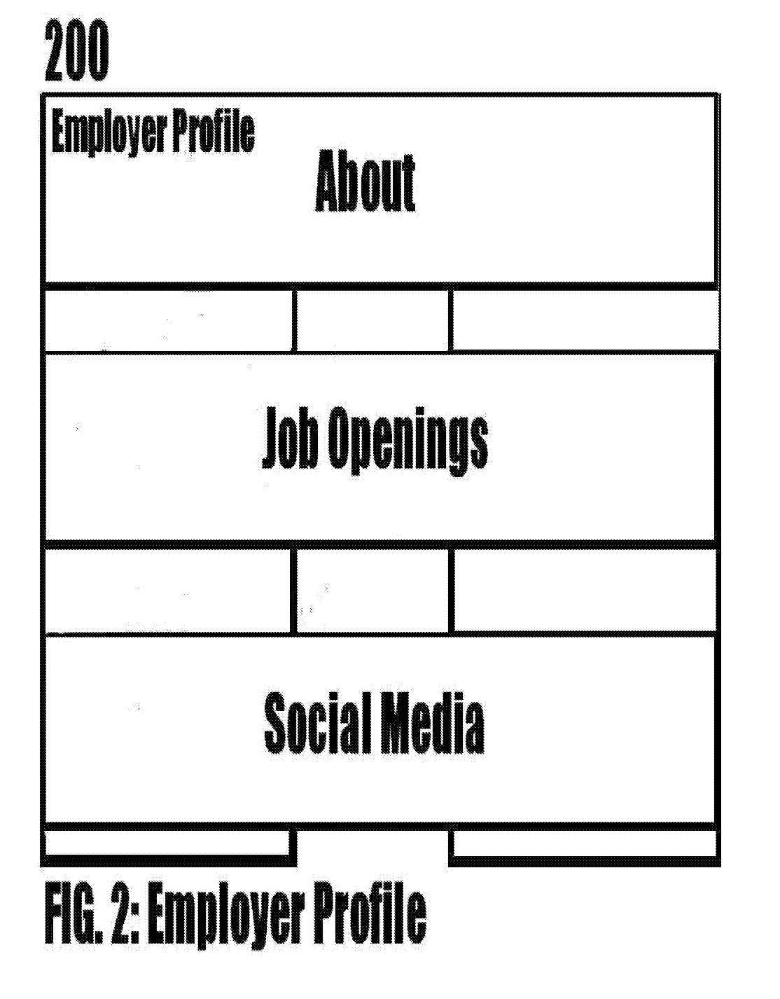

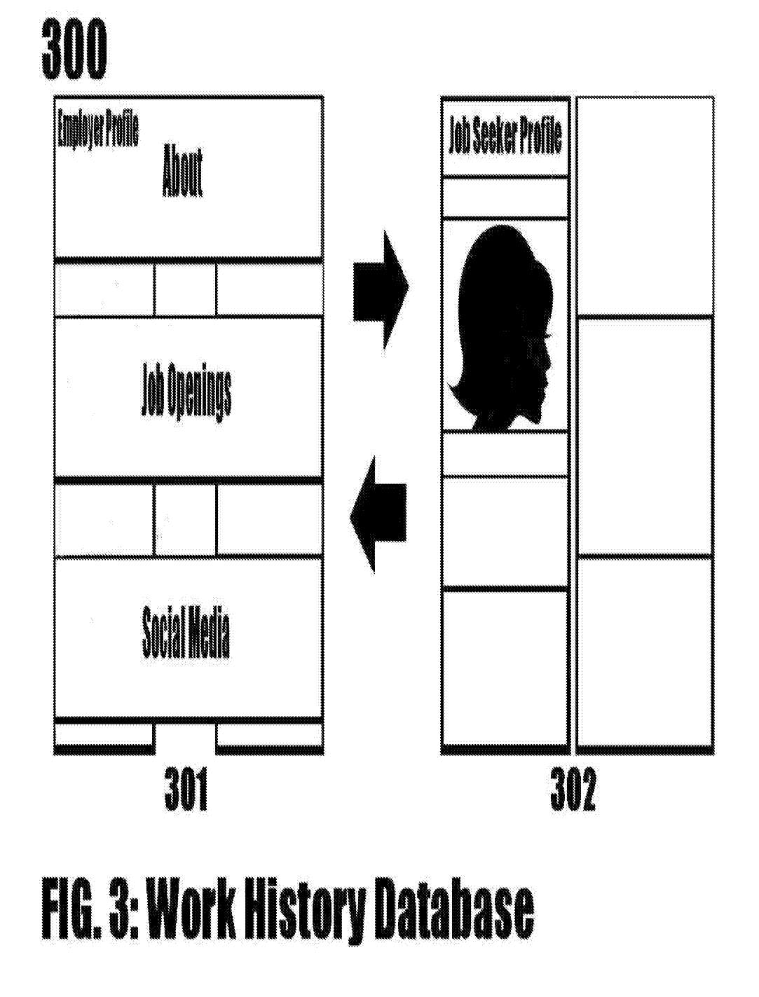

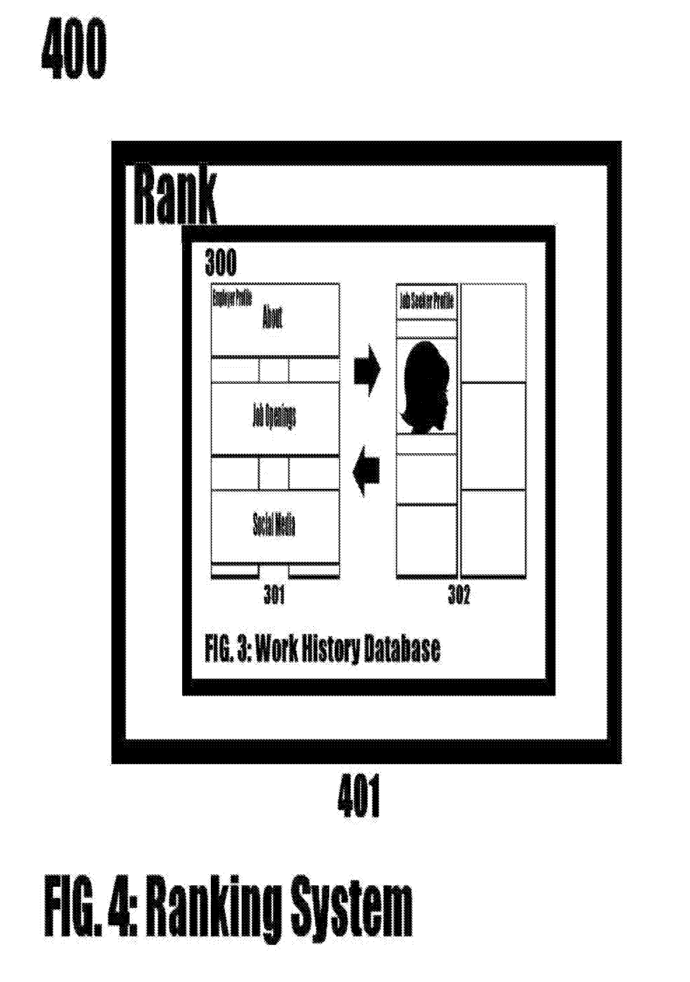

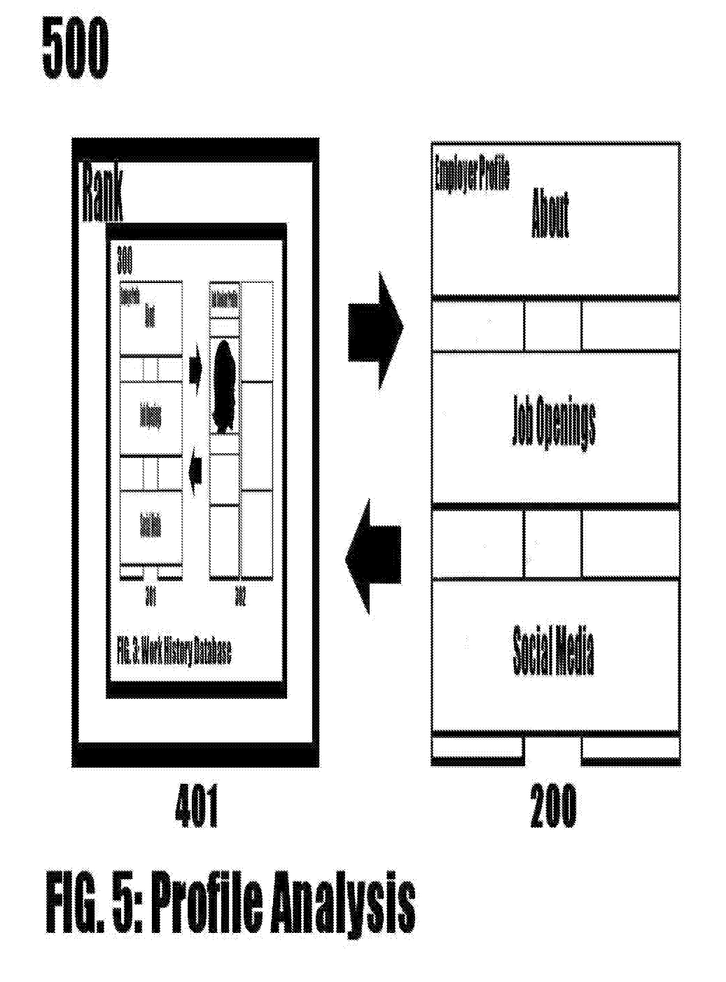

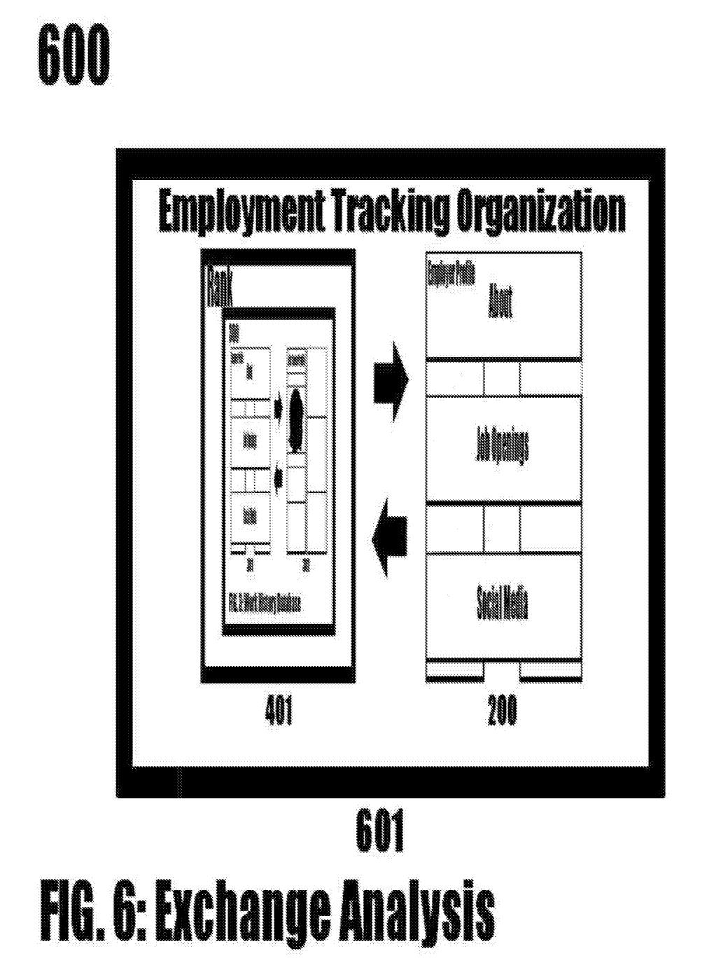

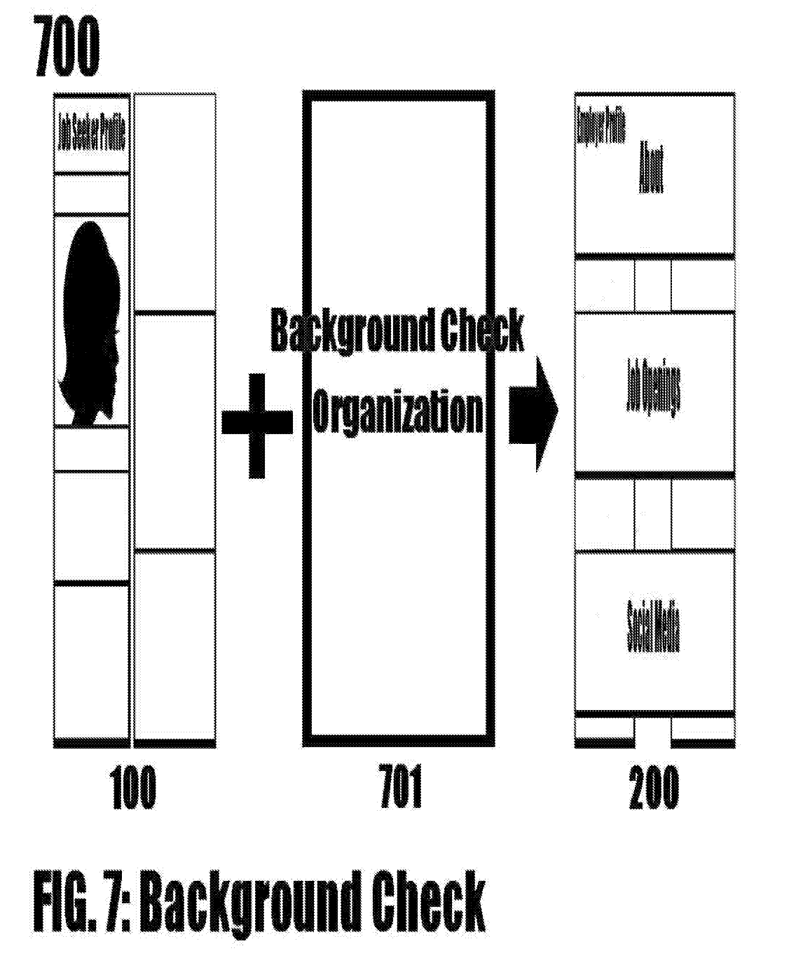

Please refer to the drawings at the end of this example for a key to the reference numbers

| Drawings | Name of Step |
|---|---|
| FIG. 1 | JOB SEEKER PROFILE |
| FIG. 2 | EMPLOYER PROFILE |
| FIG. 3 | WORK HISTORY DATABASE |
| FIG. 4 | RANKING SYSTEM |
| FIG. 5 | PROFILE ANALYSIS |
| FIG. 6 | EXCHANGE ANALYSIS |
| FIG. 7 | BACKGROUND CHECK |

### Overview:

The Decision Making Add-on System is designed to centralize the employment cycle, for all participants, linking the detailed and chronological work history of every Job Seeker/Employee (100, 302), profiled on the system, with a documented account of their work experience, submitted by their past and present Employers (200, 301). The Decision Making Add-on System will host and archive the entire work history of each employable worker (100, 302) and the relationships they have had with past and present Employers (200, 301), mapping a database that assists in the decision making of future Employers to be decided soundly and deduced with a higher degree of accuracy. The embodiments of the Decision Making Add-on System will collect data points consisting of;
1. work search history;
2. application submissions;
3. initial and fulfillment hiring protocols;
4. work related reports; write-ups, awards, promotions, formal and informal complaints, performance reviews, retirements, discharges, firings, etc.;
5. background check reporting for each prospective employee upon the request of an Employer;
6. Composite ranking of each prospective Employee based on prior work history.
   All data points will be discoverable and retrievable by Employment Tracking Organizations, exclusively.

The Decision Making Add-on System is an application program add-on which installs upon the client web server and becomes primarily responsible for the ongoing described efforts provided. During the installation process (and thereafter), client information is collected by the application program and/or the application program add-on at the client web server. The application software/application software add-on then relays this client information to the company web server across the internet for further use. Content is then downloaded from the company server to the client web server across the internet. After its receipt, the content is supported upon the client web server to support the efforts of the company.

A better understanding of the present invention can be obtained when the following detailed description of the preferred embodiment(s) is considered in conjunction with the following drawings, in which:

FIG. 1 (JOB SEEKER PROFILE) (100) illustrates a Job Seeker's profile page, comprising of multiple fields enabling an individual employed or seeking employment to correspond with current and future Employers and market their work history and personalized flare to prospective Employers.

FIG. 2 (EMPLOYER PROFILE) (200) illustrates an Employer's profile page, comprising of multiple fields enabling an Employer to correspond with current and prospective employees and analyze discoverable data fields to assist in the future decision making staff recruitment.

FIG. 3 (WORK HISTORY DATABASE) (300) illustrates the correspondence between a current Employer (301) and its current employee (302), documenting a record of all of their work related interactions.

FIG. 4 (RANKING SYSTEM) (400) illustrates a ranking system (401), comprised of an assessment of an employee's/job seeker's work history, assigning a rank (401) of the job seeker's profile, based on a categorical point system.

FIG. 5 (PROFILE ANALYSIS) (500) illustrates an Employer's (200) ability to analyze the components of a prospective employee's (100) rank, work history and profile entries.

FIG. 6 (EXCHANGE ANALYSIS) (600) illustrates the analytical database of discoverable profiles, that an Employment Tracking Organization will be granted access to, assisting in their ability to analyze data points.

FIG. 7 (BACKGROUND CHECK) (700) illustrates a request for a background check to be performed on a prospective employee (100), by a Background Check Organization (701), under the authorization of a prospective Employer (200).

### DETAILED DESCRIPTION OF THE INVENTION:

The preferred relationship among elements, including preferred logical sequencing is respectively illustrated in sequential order from FIG. 1 (JOB SEEKER PROFILE) and FIG. 2 (EMPLOYER PROFILE) to FIG. 6 (EXCHANGE ANALYSIS) and FIG. 7 (BACKGROUND CHECK) with the programmable consideration that the entire “Decision Making Add-on System” is dependent on the full participation of all elements to allow the system to operate at the fullest extent of its designed potential.

FIG. 1 (JOB SEEKER PROFILE) and FIG. 2 (EMPLOYER PROFILE) of the “Decision Making Add-on System, is the first phase of the interactive community of a Software as a Service (SaaS) networking system, enabling Employer Profiles (200) and Job Seeker Profiles (100) to exchange and share information discoverable on the embodiment's database. The goal of this aspect of the total embodiment is to connect queried profile selections (100, 200), based on opportunity variables that assist Employers (200) and Job Seeker (100) in making informed decisions on task fulfillment.

FIG. 1 (JOB SEEKER PROFILE) (100) is an individual representation of a plurality of Job Seeker/Employee profiles that are networked within the embodiment, for the purpose of allowing each defined profiler to provide recommendations to Employers on the behalf of other Job Seekers and or employees. Likewise, within the defined networking of employees/Job Seekers, each are empowered to provide insight and recommendation to each other, about various employment opportunities. All recommendations can and may be displayed and or attached to the participating parties' profile page(s), at the discretion of the profile host(s).

FIG. 3 (WORK HISTORY DATABASE) (300) illustrates the exchange of information between an Employee (302) and the employee's Employer (301), via their individual profiles (301, 302). The profile communication between the Employee and the Employee's Employer is chronicled from the Employer's first solicitation of a job opening; the job seeker's application submission; the Employer's decision to hire; and finally, their respective working history. The black arrows, pointing left and right, highlight the exchanging of information points between the Employer (301) and the Employee (302). The information points exchanged between the Employer's Profile (301) and the Employee's Profile (302) can include:

job announcements, job applications, write ups, Equal Employment Opportunity (EEO) citations, promotions, awards, suspensions, etc.;

all information points can be discoverable in one embodiment of the application, by participating parties (301, 302), Future Employers (200) and Employment Tracking Organizations (601). It is also at this point (FIG. 3 (WORK HISTORY DATABASE) (300) that documented complaints, as it relates to:

Union related matters,Equal Employment Opportunity cases, etc., can be exchanged and submitted to the governing bodies that oversee these issues.

The FIG. 4 (RANKING SYSTEM) (400) portal is inclusive of the embodiment of The FIG. 3 (WORK HISTORY DATABASE) (300) portal with exclusive content parts, comprising a composite scoring of a Job Seeker (100), based on the Job Seeker's (100) and Past Employers' (301) documented work history (300). A “Rank” will be determined by a rating of the performance of the Job Seeker (200) based on the Job Seeker's work history with the Job Seeker's Past Employers, graded on a predetermined field of performance entries submitted by the Job Seeker's (100) Past Employers.

FIG. 5 (PROFILE ANALYSIS) (500) illustrates the Employer's (200) analysis of a Job Seeker's Profile (100), enabling the Employer to view the Job Seeker's detailed work history (300) and overall employment ranking (400). The 2 opposing black arrows illustrates the Employer's Profile (200) reviewing the detailed profile of the Job Seeker (401) and the black arrow pointing back to the Job Seeker's Profile (401) illustrates the decision of the Employer (200) to employ or reject the offer presented by the Job Seeker's Profile (100); highlighting the fulfillment of the system's decision making process.

FIG. 6 (EXCHANGE ANALYSIS) (600) illustrates the analysis of a Job Seeker's Profile (100) by an Employment Tracking Organization (601) (government). The access of the Employment Tracking Organization (601) allows for them to view the work history (400) and the work search attempts (300, 400, 500, 700) performed by the Job Seeker (100).

The analysis portal (600), being a channel granting exclusionary access, will be equipped to enable government agencies, providing benefits, the ability to register eligible candidates into the system and track their systemic eligibility. Benefactors and or pursuers of government program benefits will be allowed to register a supplemental profile within the embodiment.

FIG. 7 (BACKGROUND CHECK) (700) illustrates the fulfillment of a background check request submitted by an Employer (200), performed by a Background Check Organization (701). The Background Check Organization (701) will perform a background check on any prospective employee (100) requested by an Employer (200) upon a request submitted via the system.

The Decision Making Add-on System (100, 200, 300, 400, 500, 600, 700) drawings are pictorial diagrams, illustrating an example of a single content service network configuration according to the total embodiment of the invention. The Decision Making Add-on System (100, 200, 300, 400, 500, 600, 700) is an information “exchange” (100, 200, 300, 400, 500, 600, 700) for content/service providers, and is used to provide services, including content services and remote services, to one or more Job Seekers/Employers/Employment Tracking Organization(s) (100, 200, 301, 302, 601) over a peer driven networking configuration. The network may be part of wide area network (WAN) such as the interact, a local area network (LAN), a metropolitan area network (MAN), or a combination thereof. The Decision Making Add-on System (100, 200, 300, 400, 500, 600, 700) provides an industrialized content service infrastructure that is able to continuously provide high quality and cost effective services remotely to and between Job Seekers (100) and Employers (200) and real-time, uploaded selections of requested field content (300, 400, 500, 600, 700) electronically delivered to the requestor's (100, 200, 301, 302, 601) designated Profile. Content services may be delivered on-demand (also referred to as “made-to-order”), data-retrieval based, and by fee-based subscription. Remote services may be delivered together with other agents that provide onsite support when needed, ongoing. This configuration focuses on standardized country and industry content as well as requester-specific requirements (e.g., made-to-order).

In one embodiment of the invention, it is expressed that a “background check” will be performed, upon the request made by an Employer, during the employment process, as a act of corporate due diligence. It is also prudent to note that the performance of a “background check” on a recruited Job Seeker (100) is an act of which may be fulfilled by an outside entity or executed, internally, by an embedded protocol. The decision to assign the act to be performed by an outside entity or by embedded programming techniques will be determined by “best practice” or “best intention” considerations.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

The invention disclosed herein is susceptible to various modifications and alternative forms. Specific embodiments thereof have been shown by way of example in the drawings and detailed description. It should be understood, however, that the drawings and detailed description thereto are not intended to limit the invention to the particular form disclosed, but on the contrary, the invention is to cover all modifications, equivalents and alternatives falling within the spirit and scope of the present invention as defined by the claims.

1. A computer-implemented method for compiling employment data from subscribers and/or registered profile users (Job Seekers, Employers, Employment Tracking Organizations; etc.), assisting Employers and Employment Tracking Organizations in the decision making process, designed and comprised of:
A. detailed work search history profile storage;
B. employment application submission(s) storage;
C. employment profile status update storage;
D. work related report(s) (exchange and submission) profile storage;
E. background check reporting for each prospective employee upon the request of an Employer;
F. Composite ranking of each prospective Employee based on prior work history;
all data points being discoverable and retrievable by Employment Tracking Organizations exclusively;
an add-on software interactive interface designed to enhance the capabilities of a bridged Software as a Service (SaaS),
an embedded background checking software option; either hosted by the system itself and/or bridged from an outside provider;
embedded discoverable content accessible to assigned and defined fields;
downloading, across the internet, an application program and an application program as an add-on from a hosting web server to each of a plurality of client web servers;
installing the add-on software application upon each of the plurality of client web servers;
for each application program installed, installing the add-on software application program upon the corresponding client web server;
Employee/Job Seeker profile user may be granted, based on subscription and or best practice method, the ability to limit and or restrict access and or the visibility of decided and or determined aspects of their individual profile(s);
an add-on software platform compatible with all web based communication devices (cell phones, laptops, desktops, etc.);
recommendation subsection of a Job Seeker's Employee's profile can be applied to enhance the marketability of a profile, based on uploaded, downloaded, profile link and/or tag, social media profile access and comment post, etc. content;
techniques employed to network Job Seekers/Employees, for the purpose of providing recommendation for Job Seekers/employees and Employers;
techniques employed to allow Employment Tracking Organization/Government Organization to register all benefactors of their program offering, in an effort to track the said benefactor's and or pursuer's, individual and continuous eligibility, through the system;
techniques employed will serve as a decision making software application, designed to assist Employers in making detailed assessments of prospective candidates, aiding them in their selection process.

2. The method of claim 1, wherein an add-on application provides a detailed work search history profile storage comprising:
Data collection of the work history of an Employee/Job Seeker into a web based profile proxy, storing a plurality of past employers, performance reviews, performance records, date(s) of hirings), date(s) of firing and or transitioning within.

3. The method of claim 1, wherein an add-on application provides employment application submissions and profile storage comprising:
Data collection of all of the employment applications submitted, of a plurality of Job Seekers registered into the system, discoverable without regard to the fulfillment of the employment process.

4. The method of claim wherein an add-on application provides employment status update profile storage comprising:
Data collection of employment status updates, in real time, detailing the current employment statuses of a plurality of Employees/Job Seekers, based on their interactive work history's automated updating.

5. The method of claim 1, wherein an add-on application provides work related report exchange and submission profile storage comprising:
Data collection of write-ups, awards, promotions, formal and informal complaints, performance reviews, retirements, discharges, firing, etc.; allowing the exchange, submission and storage to and on all of the network parties' profiles involved and or assigned to participate and or govern the proceedings.

6. The method of claim 1, wherein an add-on application provides background check reporting for each prospective employee upon the request of an Employer comprising:
An embedded and or an outsourced application networked within the framework of the software, to perform the background checking of a specific party of the Job Seeker field, upon the request of an Employer from time to time.

7. The method of claim 1, wherein an add-on application provides a composite ranking of each prospective employee based on prior work history comprising:
Data collection of all of the performance accounts of past and or present Employees, analyzed, to form a composite score of, or rank, based on an internal grading system, governed by an evolving standard of decided matrices from time to time.

8. The method of claim 1, wherein an add-on application provides the allowance of all data points to be discovered and retrieved, exclusively, by Employment Tracking Organizations comprising:
Access to all data collected throughout the operation of the system, granted to Employment Tracking Organizations, exclusively.

9. The method of claim 1, wherein an add-on application provides techniques employed to network Job Seekers/Employees, for the purpose of providing recommendation for Job Seekers/employees and Employers comprising;
A networked community, aligning employees and Job Seekers, to empower them to make recommendations to Employers on the behalf of other Job Seekers/Employees and to make recommendations to other Job Seekers/Employees about various Employment opportunities.

10. The method of claim 1, wherein an add-on application provides techniques employed to allow Employment Tracking Organization/Government Organization to register all benefactors of their program offering, in an effort to track the said benefactor's and or pursuer's, individual and continuous eligibility, through the system comprising:
A supplemental profile registration for benefactors of government program offerings, which will grant, Employment Tracking Organizations/Government Organizations, profiled access to each individual benefactor and benefit pursuant.

11. A method of claim 1, further comprising:
Techniques for performing enhanced decision making protocol upon the internet, based on the analysis of the exchange of, submission of, downloading of, uploading of and data entering of, voluntary and tiered, peer profile entries comprising of:
Downloading, across the internet, an application program and an application program add-on from a company web server to each of a plurality of client web servers;
Installing the application program upon each of the plurality of client web servers;
For each application program installed, installing the application program add-on upon the corresponding client web server;
Techniques for performing software indexing for profile specific discoverable and retrievable system content, from a plurality of client web networked profiles, for the purpose of personalizing content for each member of the system's client network, in real time.

12. A method for generating and displaying information relating to a profiled Job Seeker's employment history, performance and background comprising the steps of:
in response to clients collectively entering previous or current work history data, correlated data points are “indexed,” within the network, back to each bridged network source, to validate and personalize data points, in real time, for a selectable and discoverable profile;
identifying the work history, performance reviews, and composite rank within a database that relates to a profiled Job Seeker, said records containing data indexed within the system relating to a profiled job Seeker's complete work history, said database having records of previous employment with a plurality of profiled Employer;
determining the performance history of a selected profiled Job Seeker based on downloaded, submitted and or exchanged documents, reviews, awards, report, etc. that support an in depth analysis of a profile client's work record;
if a profile client is determined to be a favorable hire for a profiled Employer, a request may be communicated to the system to perform a background check on the selected prospect; performed internally or outsourced;
if no issues are found to discourage the hiring of a profiled Job Seeker, the decision to hire is left to be determined by the profiled Employer.
